(19) United States
(12) Patent Application Publication
(10) Pub. No.: US 2014/0303930 A1
(43) Pub. Date: Oct. 9, 2014

(54) METHOD AND AN APPARATUS FOR PARAMETERIZING A SENSOR

(71) Applicant: AVL LIST GMBH, Graz (AT)

(72) Inventors: Peter Priller, Judendorf-Strassengel (AT); Michael Paulweber, Hausmannstatten (AT); Rupert Fellegger, Graz (AT)

(73) Assignee: AVL LIST GMBH, GRAZ (AT)

(21) Appl. No.: 14/353,977

(22) PCT Filed: Oct. 2, 2012
(86) PCT No.: PCT/EP2012/069443

§ 371 Date: Apr. 24, 2014

(30) Foreign Application Priority Data
Oct. 27, 2011 (AT) A 1581/2011

(51) Int. Cl. G01B 21/16; G01M 17/00

(52) U.S. Cl. CPC G01B 21/16; G01M 17/00
USPC 702/152

(57) ABSTRACT

Sensors in a test bench environment have to be parameterized in advance. This is a complex task that up to now has been performed mostly manually by a test bench engineer. In order to make the parameterization of a sensor (54) easier, it is proposed that the position of the sensor on the object under test (1) be ascertained through suitable localization methods and the ascertained position be compared with geometric data of the object under test (1), from which the position of the sensor (54) on the object under test (1) can be derived, and from this position on the object under test (1), the variable physically measured by the sensor (54) can be assigned to the sensor (54).

The present invention relates to a method and an apparatus for parameterizing a sensor that is fitted on an object under test on a test bench.

In test benches for objects under test such as, e.g., internal combustion engines, drive trains, vehicles etc., usually a multiplicity of sensors are installed in order to be able to record the data necessary for the current test in task. For this purpose, the sensors are attached at certain locations on the object under test and have to be parameterized prior to measurement so as to ensure a correct measurement. Parameterizing comprises assigning the sensor type to the sensor, thus assigning the sensor to its measured physical variable and determining the position of the sensor on the object under test, thus the measuring point, e.g., the oil pressure in the cylinder head on the left, or the exhaust gas temperature upstream of the catalytic converter. Furthermore, parameterizing can also comprise assigning the sensor type, e.g., pressure sensor type xyz or temperature sensor type xyz so as to enable the measuring system to apply the corresponding transfer function of the sensor and thus to be able to derive from the measured variable the physical variable applied at the sensor. Likewise, parameterizing can comprise assigning the serial number of the sensor, or a sensor identification, or necessary calibration data. These data are in most cases stored in the test bench environment, e.g., in the test bench computer or in the automation system. Parameterizing takes place manually, this means that a test bench engineer has to parameterize the different sensors individually, thus has to assign the required information, which, due to the multiplicity of sensors and the variety of information to be assigned is a complex and error-prone task.

In this context, methods have already become known which facilitate the calibration of sensors. EP 1 300 657 A1 describes, e.g., a method in which the calibration data of a sensor are linked to the same so that calibrating can take place semi-automatically or automatically. For this purpose, a sensor identifier is stored in the sensor, by means of which sensor identifier calibration data can be retrieved from an external storage. Although the sensor can be calibrated automatically, thus can be prepared for the measurement; however, it is not defined yet what this sensor measures. For example, a plurality of pressure sensors, usually of the same type, can be installed on an internal combustion engine. The pressure sensors can now calibrate themselves automatically and deliver now measurement data to the test bench software. However, this does not define yet from which location on the combustion engine the measurement variables were obtained. This assignment has still to be done manually by the test bench engineer.

It is therefore an object of the present invention to make parameterization of a sensor at least easier with respect to the prior art and to enable at least a partially automatic parameterization.

This object is achieved with a method and an apparatus in which the sensor transmits information that is recorded by a recording device and therefrom, the spatial position of the sensor is ascertained through a localization method, the ascertained sensor position is compared with geometric data of the object under test, and through this comparison, the position of the sensor on the object under test is determined, and subsequently, the sensor is parameterized in that based on the ascertained position on the object under test, the variable physically measured by the sensor is assigned to the localized sensor. By automatically determining the sensor position on the object under test and the physical variable measured by the senor, parameterizing can already be made significantly easier. The test bench engineer is already provided with a parameterized sensor in the form of the assignment of the measured physical variable to a measuring point, which makes assigning the sensor type and the specific sensor significantly easier because only small quantity remains for selection.

If an automatic assignment of sensor position and the kind of sensor is not possible due to ambiguity in the ascertained position or the ascertained physical variable, advantageously, a proposal for manual selection of the correct position or physical variable is offered. Thus, the test bench engineer is able to very quickly assign the correct sensor kind or sensor position, which makes parameterizing at least easier.

Preferably, the sensor transmits as information what kind of sensor it is, which makes it possible to derive the physical variable of the sensor kind assigned to the sensor. Thus, it is sufficient to determine the position of the sensor on the object under test since the sensor kind is provided by the sensor. Nevertheless, the sensor type could also be ascertained from the sensor position which then could be compared with the transmitted sensor kind, which can assist in avoiding possible parameterization errors.

When the sensor transmits the information about its sensor type, and parameterizing comprises assigning the physically measured variable and/or the sensor type to the localized sensor, parameterizing can largely take place in an automated manner, which significantly reduces the complexity of parameterizing.

It is particularly advantageous if the sensor transmits as information a unique sensor identifier, and based on the sensor identifier, the physically measured variable and/or the sensor type and/or calibration data are assigned to the localized sensor.

Thus, a completely automated parameterization is possible, as a result of which the complexity for parameterizing can be minimized.

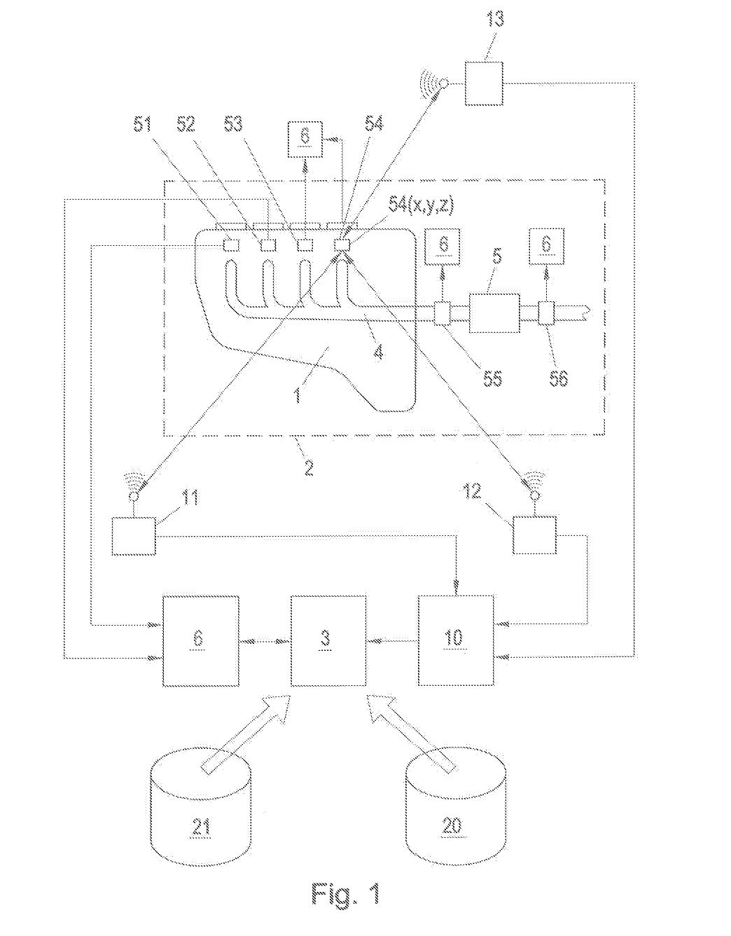

The present invention is described with reference to FIG. 1, which shows a preferred configuration of the invention in an exemplary, schematic and non-limiting manner. In the figures:

FIG. 1 shows an arrangement of the parameterization according to the invention.

In FIG. 1, an object under test 1, here, an internal combustion engine with an exhaust gas system 4 and a catalytic converter 5 is arranged on a test bench 2 that is only indicated. Such test bench arrangements are well known, which is the reason why details thereof are not discussed here. Apart from an internal combustion engine, other objects under test 1 such as, e.g., a drive train, a transmission, a vehicle, etc. can also be considered, of course. As is usual on a test bench 2, a series of sensors 51, 52, 53, 54, 55, 56 are installed on the object under test 1. The sensors 51, 52, 53, 54, 55, 56 transmit their measured values, via wire or wireless, to an automation system 6 that monitors and controls the test bench 2, the object under test 1 and the test run, and also evaluates the test run result. In order for the sensors 51, 52, 53, 54, 55, 56 to be used, they first have to be parameterized so that the measured values of the sensors 51, 52, 53, 54, 55, 56 can be converted into correct physical values. Thus, the automation system 6 needs to know from where the measured value is originated on the object under test, and what the sensor 51, 52, 53 54, 55, 56 located thereon measures, This information must be given to the automation system 6 prior to the start of the test run.

For this purpose, a localization unit 10 is provided which, by using a suitable localization method, determines first the position of the sensor 51, 52, 53, 54, 55, 56. Such localization methods are well known per se, and any method suitable for the invention can be used such as, e.g., triangulation, trilateration, distance measurement with electromagnetic waves (e.g. microwaves) or sound waves (e.g., ultrasound), methods based on Doppler effect, laser measurement, image recognition, etc. These localization methods use information (actively or passively) transmitted by sensors so as to determine therefrom a position according to the applied method. The information is recorded by a recording unit and evaluated. Transmitting information from the sensor 51 52, 53, 54, 55, 56 can be carried out actively, e.g., by encoded transmission of a message, or passively, e.g., by a tag on the sensor that can be read or targeted by optical methods. For example, in the case of triangulation, the angles of a reference point to the measuring point are ascertained and from there, the spatial position of the measuring point is determined. In the case of trilateration, the distances of a reference position from the measuring point are ascertained. Here a passive, e.g., optical, or an active, e.g., radio-based angle or distance measurement can be used. In the case of laser measurement, a measuring point is targeted by a laser beam, and the reflected laser beam is recorded and evaluated, e.g., with regard to the phase or travel time.

This is illustrated in FIG. 1 using the example of an ultrasound-based localization method. For this, three ultrasonic transducers 11, 12, 13 are arranged as a recording device, wherein it is also possible to provide more transducers. The individual sensors 51, 52, 53, 54 55, 56 successively transmit an ultrasonic signal, e.g., an encoded defined message. In principle, any transmission protocol and any suitable data format can be used for data transmission. Based on a travel time measurement, the distance between the sensor 54 and the individual ultrasonic transducers 11, 12, 13 and thus the spatial position of the sensor 14 with regard to the ultrasonic transducer 11, 12, 13 or any other reference position can be ascertained. The localization unit 10 transmits the determined sensor position 54(x, y, z) to a parameterization unit 3. As in the present case, the parameterization unit 3 can be, e.g., an independent unit in the test bench environment; however, it can also be integrated in the automation system 6 of the test bench 2 or in the localization unit 10.

In geometry data base 20, geometric data for the object under test 1 are stored, which data can be accessed by the parameteriation unit 3. Geometric data can be any data that describe the object under test 1 in the form of spatial points or components with their spatial position, e.g., 3D CAD data from a design environment. Each component of the object under test 1 is defined and known here by its three-dimensional extent. By comparing the determined sensor position 54(x, y, z) with the geometric data in the parameterization unit 3, the position of the sensor 54 on the object under test 1 or the arrangement of the sensor on a certain component of the object under test 1 can be ascertained, as a result of which the context between position and sensor can be established.

For this, possible installation points for the sensors can already be defined during the design phase of the object under test, and can be stored in the design data (e.g. CAD data). Of course, they can also be added at a later time to already existing design data. For example, at the position (x, y, z) a hole could be defined together with describing data such as “measuring point for temperature sensor” or, even more specific, together with an associated standard name, e.g., measuring point “T_EX_C01”. In this manner, assigning the position to the measuring task )thus to the measured physical variable) is clear and simple. However, for this the design data have to be prepared appropriately, which, however, needs to be done only once.

Alternatively, the design data (e.g., CAD data) can also include a component list. From the component list itself or from additional describing texts or additional tags for each component, it is then possible, e.g., by means of a given word list which includes the possible components, to determine the component through word comparison.

Furthermore, in general, heuristics could also be defined, from which then the most likely position of the sensor can be determined. For this, in addition and analogous to the localization of the sensors, additional reference points on the object under test could be measured so as to support the localization of the sensor. The additional reference points can describe measuring point positions (e.g., oil pan, exhaust gas system, cylinder head, etc.) for typical configurations for objects under test relative to these reference points. Such heuristic-based rules, e.g., could define something like “oil pan is at the bottom”, “exhaust gas system is at the side”, “cylinder head is above the oil pan”, etc. Of course, methods of artificial intelligence such as, e.g., neuronal networks or expert systems can also be used.

Of course, this comparison can also be carried out in the localization system 10. In this manner, each sensor 51, 52, 53, 54, 55, 56 can be assigned to at least one component or a spatial position. From the assigned position, the sensor type can then be derived. In many cases, this enables a clear identification of the sensor kind. For example, when identifying the sensor position “exhaust gas outlet; cylinder 1”, it can be concluded that a temperature sensor is involved since it makes no sense to use a different sensor on this component. Subsequently, the measurement variable “temperature port cylinder 1” and even the associated standard name, here, e.g., T_EX_C01, to be assigned thereto can also be allocated. This information, namely which sensors are possible for which component or which spatial position, can be stored in the parameterization unit 3 or in a sensor data bank 21 or at a different suitable storage location.

At other components of the object under test, only an ambiguous assignment of the sensor position to the sensor kind will be possible. For example, in the oil channel of in engine, temperature sensors and pressure sensors can be arranged directly next to each other. When ascertaining the position “in the oil channel”, at least a limited selection (here, temperature and pressure) can be offered, which then can be assigned manually and correctly and the test bench engineer, as a result of which parameterizing is at least made significantly easier.

If no clear ascertaining of a component or a position of the sensor 54 on the object under test is possible, it is also possible to offer the test bench engineer a selection of possible components or positions for manual selection, which at least makes parameterizing easier.

Thus, based on the automatically identified position alone, the sensors 51, 52, 53, 54 55, 56 can be at least partially automatically parameterized. In this case, automatic parameterization comprises only determining the position of the sensor 51, 52, 53, 54, 55, 56, and based thereon, determining the measured physical variable (thus the sensor kind) of the sensor. The further assignment of the specific installed sensor, thus, e.g., sensor type and calibration data, to the ascertained position can be carried out manually.

In an improved configuration, a sensor 51, 52, 53, 54, 55, 56 transmits not only a neutral encoded message, but also the kind of the sensor 51, 52, 55, 54, 55, 56, thus the kind of the measured physical variable such as, e.g., pressure, temperature, oxygen concentration, etc. The sensor kind, e.g., can simply be transmitted in the form of additional information such as, e.g., “1” for temperature, “2” for pressure, etc. Thus, a clear assignment of sensor kind to the ascertained position can be performed in an automated manner, even in cases in which the position allows ambiguity with regard to the installed sensor. Thus, by means of the automated parameterization, each sensor can be characterized by its position and the transmitted sensor type, thus, e.g., temperature sensor on the oil pan, oxygen sensor upstream of catalytic converter, temperature sensor downstream of catalytic converter, pressure sensor at the x-th cylinder, etc.

It is no longer necessary here to derive the sensor kind from the ascertained position of the sensor 54 on the object to under test, but can be derived directly from the information transmitted by the sensor 54. Nevertheless, the sensor kind can also be ascertained from the sensor position, e.g., in order to be able to make a plausibility comparison through redundancy, so as to avoid errors in the parameterization, or to enable parameterization even if, for any reason, the sensor kind cannot be evaluated correctly.

In a further configuration, the sensor 51, 52, 53, 54, 55, 56 also transmits the sensor type information, e.g., temperature senior PT100, pressure sensor 0 . . . 100 mBar, etc., as a result of which the sensor 51, 52, 53, 54, 55, 56 is principally already ready for use after the automatic parameterization, thus, the measured value can be converted into a correct physical value. The sensor type information can be transmitted in encoded form, e.g., in the form of an additional field in the message sent by the sensor. The information on sensor type can be transmitted in addition to the information on sensor kind. However, the sensor kind can also be derived from the sensor type, as a result of which transmitting the information on the kind of sensor can also be omitted.

In a preferred embodiment, a sensor 51, 52 53 54, 55, 56, also provides its unique identification so that the parameterization can also comprise assigning calibration data available for each sensor. For this purpose, a sensor data base 21 can be provided in which corresponding data such as, e.g., calibration data, can be stored for each sensor 51, 52, 53, 54, 55, 56 and can be retrieved via the sensor identifier. For an error-free and reliable measurement, calibrating the sensor 51, 52, 54, 54, 55, 56 is of advantage. For this, there are also corresponding standards for specifying the sensor identifier, for instance, the TEDS standard (according to IEEE 1451.4 Transducer Electronic Data Sheet). The sensor identifier preferably enables a unique identification of the sensor 54, e.g., via a sensor serial number. In this case, the sensor kind and the sensor type can also be queried from the sensor data base 21 and does not have to be transmitted specifically by the sensor 54.

Localizing the sensor 52, 53, 54, 55, 56 can also be carried out with methods of digital image recognition. For this, the sensors can be provided, e.g., with suitable image markers such as, e.g., label for the kind of sensor or a unique sensor identifier, which can be evaluated through image recognition. In this manner it is again possible to ascertain at least the position of the sensor 51, 52, 53, 54, 55, 56 and (at least in part automatically) the sensor kind. If, in addition, the sensor carries the sensor type or even a unique sensor identifier, which enables a clear identification and can be evaluated through image recognition, the parameterization as described above can also assign further information in an automated manner.

Another alternative is the use of moveable antennas, which enable the use of the Doppler-effect. Through this, position determination of the sensor 51, 52, 53, 54, 55, 56 can be made more accurate and, under certain circumstances, it is also possible to detect sensors which would not be reachable by stationary antennas or transducers.

Likewise, it can be provided to use a redundant number of antennas, transducers, image recording devices, lasers, etc. In this manner, the position of a sensor 51, 52, 53, 54, 55, 56 can be ascertained by means of different antennas, transducers, image recording devices, lasers, etc., thus can be ascertained multiple times. Averaging or probability considerations (determining the highest probability for the position of the sensor), in turn, can result in increased accuracy. This can also help in cases in which a sensor 51, 52, 53, 54, 55, 56 is arranged such that the emitted waves cannot be detected by all antennas, transducers, image recording devices, etc., e.g., due to the geometric characteristics of the object under test 1.

1. A method for parameterizing a sensor (54) that is fitted on an object under test (1) on a test bench (2), wherein the sensor transmits information that is recorded by a recording device and therefrom, the spatial position (54(x,y,z)) of the sensor (54) is ascertained through a localization method, the ascertained sensor position (54(x,y,z)) is compared with geometric data of the object under test (1), and through this comparison, the position of the sensor (54) on the object under test (1) is determined, and subsequently, the sensor (54) is parameterized in that based on the ascertained position (54(x,y,z)) on the object under test (1), the variable physically measured by the sensor (54) is assigned to the localized sensor (54).

2. The method according to claim 1, wherein the case of ambiguity in the determined position (54(x,y,z)) or in the ascertained physical variable, a proposal for a manual selection of the correct position or physical variable is offered.

3. The method according to claim 1, wherein the sensor (54) transmits as information its sensor kind, and the physical variable assigned to the sensor (54) is derived from the sensor kind.

4. The method according to claim 1, wherein the sensor (54) transmits as information its sensor type, and parameterizing comprises the assignment of the physically measured variable and/or the sensor type to the localized sensor (54).

5. The method according to claim 1, wherein the sensor (54) transmits as information a unique sensor identifier, and based on said sensor identifier, the physically measured variable and/or the sensor type and/or calibration data are assigned to the localized sensor (54).

6. An apparatus for parameterizing a sensor (54) that is fitted on an object under test (1) on a test bench (2), wherein a recording device is provided by means of which information transmitted by the sensor (54) can be recorded and can be transmitted to a localization unit (10), and therefrom, the localization unit (10) ascertains through a localization method the spatial position (54(x,y,z)) of the sensor (54), that a parameterization unit (3) is provided in which the ascertained sensor position (54(x,y,z)) can be compared with geometric data of the object under test (1), and through this comparison, the position (54(x,y,z)) of the sensor on the object under test (1) can be determined, and that subsequently, the sensor (54) can be parameterized by the parameterization unit (3) in that based on the ascertained position on the object under test (1), the variable physically measured by the sensor (54) can be assigned to the localized sensor (54).

7. The method according to claim 6, wherein the localization unit (10) or the parameterization unit (3) is adapted for offering a proposal for manual selection of the correct position or physical variable if there is ambiguity in the determined position (54(x,y,z)) or the determined physical variable.

8. The method according to claim 6, wherein the localization unit (10) or the parameterizing unit (3) is adapted for ascertaining a sensor kind transmitted by the sensor (54), and for ascertaining therefrom the physical variable assigned to the sensor (54) and assigning it to the sensor (54).

9. The method according to claim 6, wherein the localization unit (10) or the parameterization unit (3) is adapted for ascertaining a sensor type transmitted by the sensor (54) and for ascertaining therefrom the physical variable assigned to the sensor (54), and for assigning the ascertained physical variable and/or the sensor type to the sensor (54).

10. The method according to claim 6, wherein the localization unit (10) or the parameterization unit (3) is adapted for ascertaining a sensor identifier transmitted by the sensor (54) and for ascertaining therefrom the sensor type assigned to the sensor (54) and for ascertaining the physical variable assigned to the sensor (54), and for assigning the ascertained sensor type and/or the ascertained physical variable and/or calibration data to the sensor (54).
